(19) United States
(12) Patent Application Publication
(10) Pub. No.: US 2024/0186742 A1
(43) Pub. Date: Jun. 6, 2024

(54) Connector and Charging Seat Assembly

(71) Applicants: Tyco electronics (Suzhou)Ltd., Suzhou City (CN); Tyco electronics Technology (SIP) Ltd., Suzhou (CN); Tyco electronics (Shanghai) Co., Ltd., Shanghai (CN)

(72) Inventors: Fangyue (Jason) Zhu, Shanghai (CN); Ming Xu, Suzhou (CN); Jinshun (Jet) Wang, Suzhou (CN); Qun (Sunny) Zhang, Suzhou (CN)

(73) Assignees: Tyco electronics (Suzhou)Ltd., Suzhou (CN); Tyco electronics Technology (SIP) Ltd., Suzhou (CN); Tyco electronics (Shanghai) Co., Ltd., Shanghai (CN)

(21) Appl. No.: 18/524,582

(22) Filed: Nov. 30, 2023

(30) Foreign Application Priority Data
Dec. 2, 2022 (CN) 202211542028.9

(51) Int. Cl. H01R 13/516

(52) U.S. Cl. CPC H01R 13/516; H01R 13/5202

(57) ABSTRACT

A connector for connecting to a charging seat includes a housing, a cover, a conductive element or metal bar, and a connecting piece. The housing is formed with a terminal hole that allows one end of a charging terminal of the charging seat to be inserted. The cover is installed on an end of the housing and formed with a conductive element opening. One end of the conductive element is inserted into the housing through the opening of the cover. The connecting piece is provided in the housing and adapted to connect the one end of the conductive element to the one end of the charging terminal.

### CROSS-REFERENCE TO RELATED APPLICATION

This application claims the benefit of Chinese Patent Application No. CN202211542028.9 filed on Dec. 2, 2022, in the State Intellectual Property Office of China, the whole disclosure of which is incorporated herein by reference.

### FIELD OF THE INVENTION

The present invention relates to a connector for connecting to a charging seat and a charging seat assembly including the connector.

### BACKGROUND

In charging assemblies of the prior art, a copper wire is usually electrically connected to a charging terminal of a charging seat. In order to connect the wire to the terminal, a connecting terminal is typically connected at one end of the wire and fastened to one end of the charging terminal with a bolt. The connection operation associated with this arrangement, however, is very inconvenient, time-consuming and labor-intensive. Moreover, assembly of the copper wire and the housing of the charging seat is relatively complex, making it difficult to achieve automated production and requiring manual operation, greatly reducing production efficiency. In addition, in the prior art, as one end of the copper wire is inserted into the housing of the charging seat, if the copper wire requires replacement, the housing of the charging seat must be disassembled first before the wire can be removed from the charging terminal. This makes subsequent maintenance operations difficult.

### SUMMARY

According to an embodiment of the present disclosure, a connector adapted to connect a charging seat includes a housing, a cover, a conductive bar, and a connecting piece. The housing is formed with a terminal hole that allows one end of a charging terminal of the charging seat to be inserted. The cover is installed on an end of the housing and formed with a bar opening. One end of the conductive bar is inserted into the housing through the bar opening of the cover. The connecting piece is provided in the housing for connecting the one end of the conductive bar to the one end of the charging terminal.

### BRIEF DESCRIPTION OF THE DRAWINGS

The invention will now be described by way of example with reference to the accompanying Figures, of which:

FIG. 1 is an illustrative perspective view of a charging seat assembly according to an exemplary embodiment of the present invention;

FIG. 2 is an illustrative exploded view of a charging seat assembly according to an exemplary embodiment of the present invention;

FIG. 3 is an illustrative exploded view of a connector housing, an elastic seal, cover, and an end cover of a charging seat according to an exemplary embodiment of the present invention;

FIG. 4 is an illustrative perspective view of a connector according to an exemplary embodiment of the present invention;

FIG. 5 is a cross-sectional view of a charging seat assembly along an axial direction of a charging terminal according to an exemplary embodiment of the present invention;

FIG. 6 is a cross-sectional view along the axial direction of a connecting ear of a charging seat assembly according to an exemplary embodiment of the present invention;

FIG. 7 is an illustrative view of a metal bar connected to a charging terminal of a charging seat according to an exemplary embodiment of the present invention;

FIG. 8 is an illustrative exploded view of a metal bar and a charging seat according to an exemplary embodiment of the present invention;

FIG. 9 is a spatial arrangement view of metal bars according to an exemplary embodiment of the present invention;

FIG. 10 is a top view of metal bars according to an exemplary embodiment of the present invention;

FIG. 11 is an illustrative view of installing a connector housing onto a charging seat according to an exemplary embodiment of the present invention; and

FIG. 12 is an illustrative view of inserting a metal bar into a connector housing according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector adapted to connect to a charging seat is provided. The connector includes: 1) a housing formed with a terminal hole that adapted to receive an end of a charging terminal of the charging seat; 2) a cover installed on an end of the housing and formed with a conductive element hole; 3) a conductive element or bar, one end of which is inserted into the housing through the conductive element hole of the cover; and 4) a connecting piece provided in the housing and adapted to connect the one end of the conductive element to the one end of the charging terminal.

According to another embodiment, a charging seat assembly comprises the above connector and a charging seat. The charging seat includes a charging seat housing, a charging terminal arranged in the charging seat housing; and an end cover installed on an end of the charging seat housing. The housing of the connector is fixed to the end cover of the charging seat. One end of the charging terminal passes through the end cover and is inserted into the housing of the connector to be electrically connected to the conductive element of the connector.

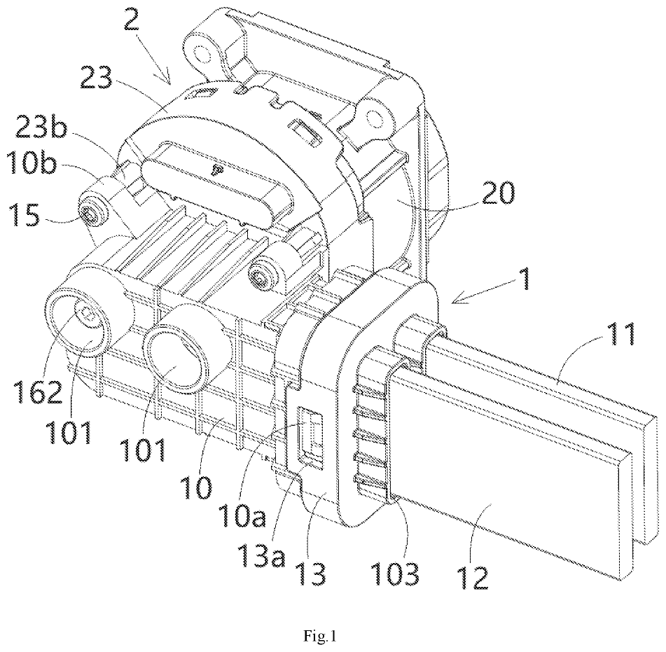

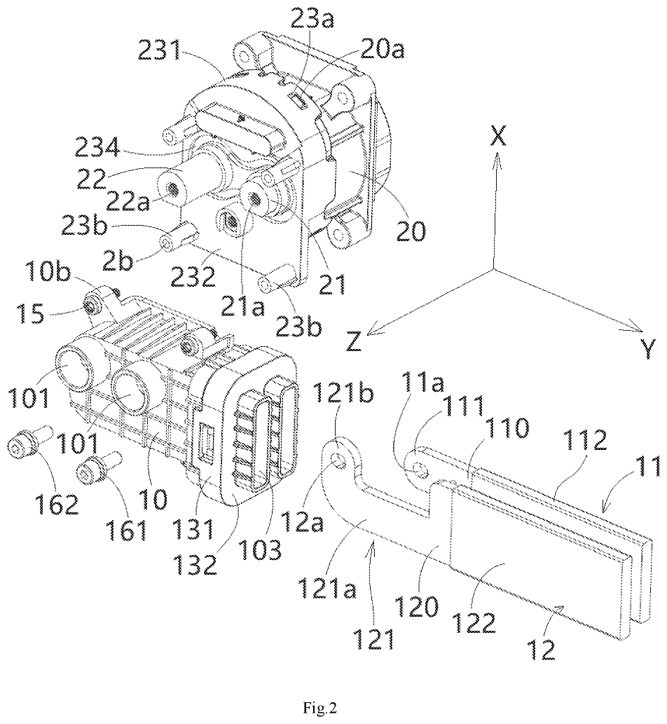

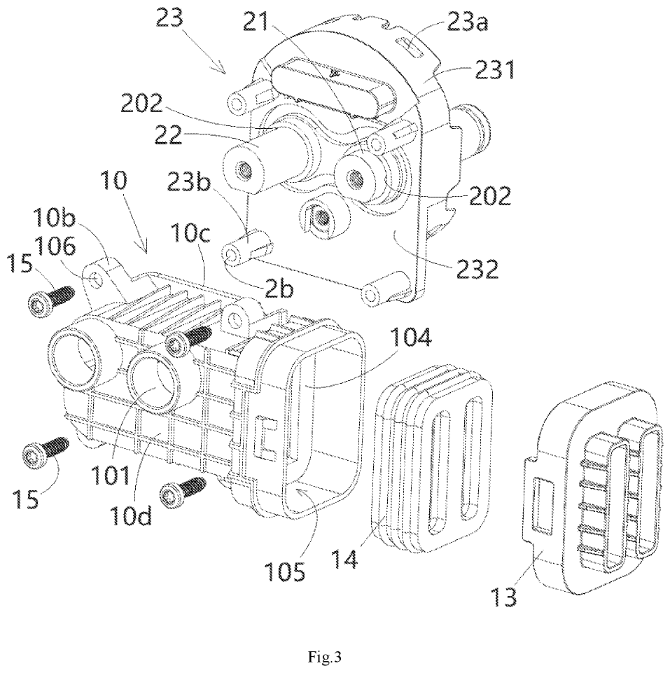

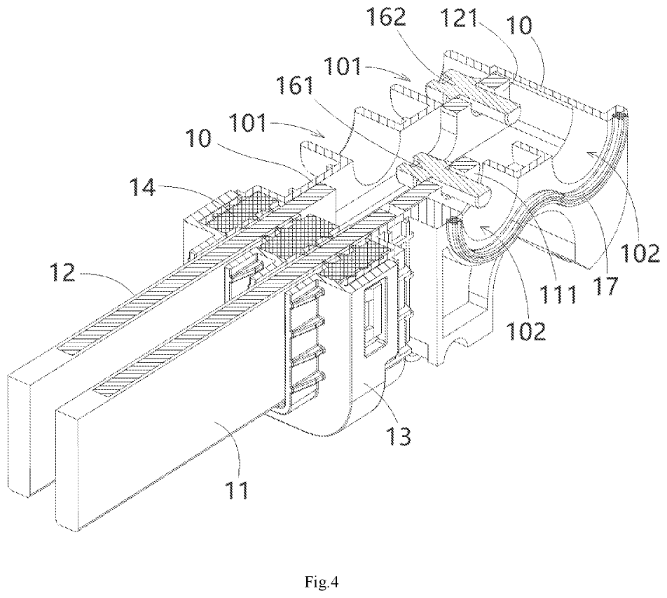

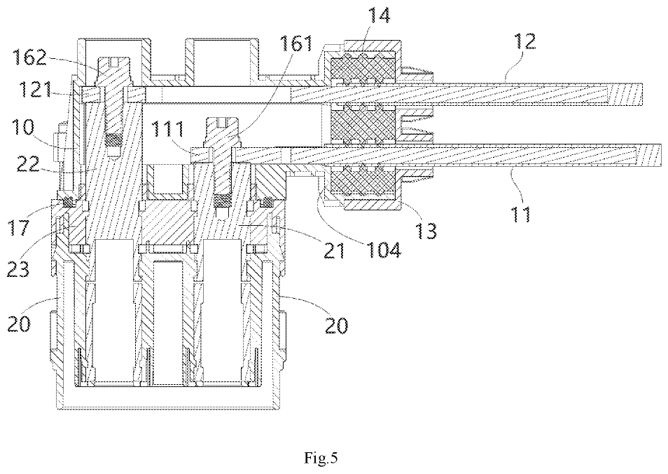

FIG. 1 is an illustrative perspective view of a charging seat assembly according to an exemplary embodiment of the present invention. FIG. 2 is an illustrative exploded view of a charging seat assembly according to an exemplary embodiment of the present invention. FIG. 3 is an illustrative exploded view of a connector housing 10, an elastic seal 14, a cover 13, and an end cover 23 of a charging seat 2 according to an exemplary embodiment of the present invention. FIG. 4 is an illustrative perspective view of a connector 1 according to an exemplary embodiment of the present invention. FIG. 5 is a cross-sectional view along an axial direction of a charging terminal 21, 22 of a charging seat assembly according to an exemplary embodiment of the present invention.

As shown in FIGS. 1-5, in an exemplary embodiment of the present disclosure, a connector 1 for connecting to a charging seat 2 is disclosed. The connector 1 includes a housing 10, a cover 13, a metal bar or conductive element 11, 12, and a connecting piece 161, 162. A terminal hole 102 is formed in the housing 10 that allows one end of the charging terminal 21, 22 of the charging seat 2 to be inserted. The cover 13 is installed on an end of the housing 10 and a metal bar hole 103 is formed in the end wall 132 of the cover 13. One end of the metal bar 11, 12 is inserted into the housing 10 through the metal bar hole 103 in the cover 13. The connecting pieces 161, 162 is arranged in the housing 10 to connect one end of the metal bar 11, 12 to one end of the charging terminal 21, 22.

In the illustrated embodiments, a snapping slot 13a is formed on the peripheral wall 131 of the cover 13. A protrusion 10a is formed on the exterior of the rear end of the housing 10. The protrusion 10a is engaged into the snapping slot 13a to fix the cover 13 to the rear end of the housing 10.

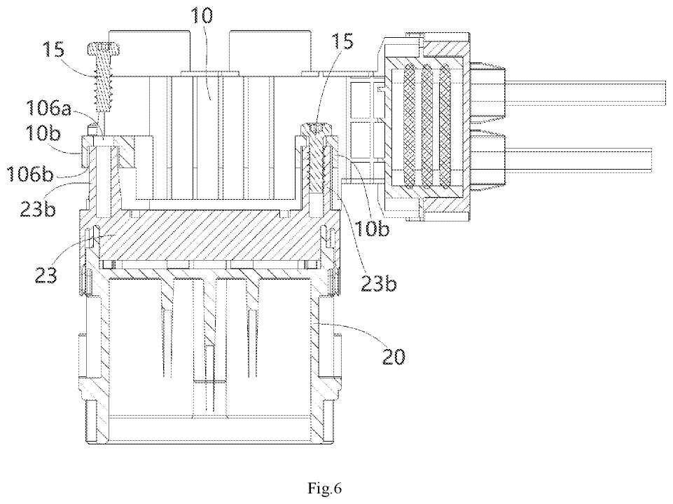

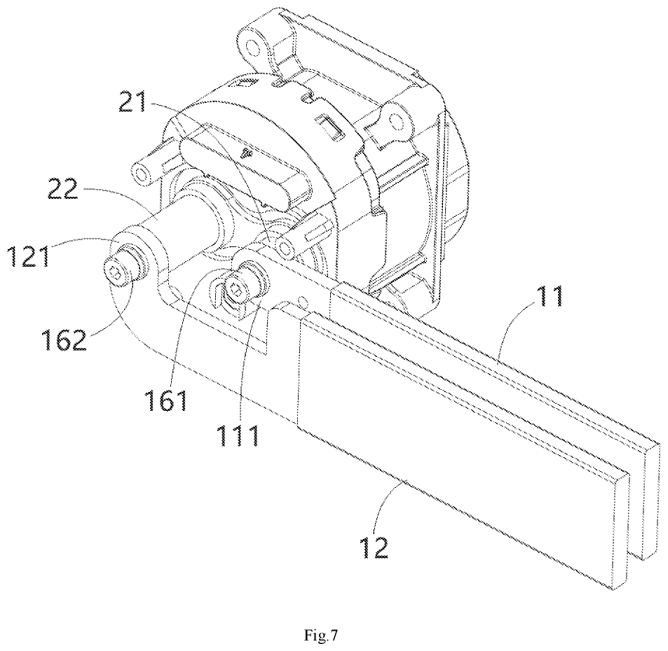

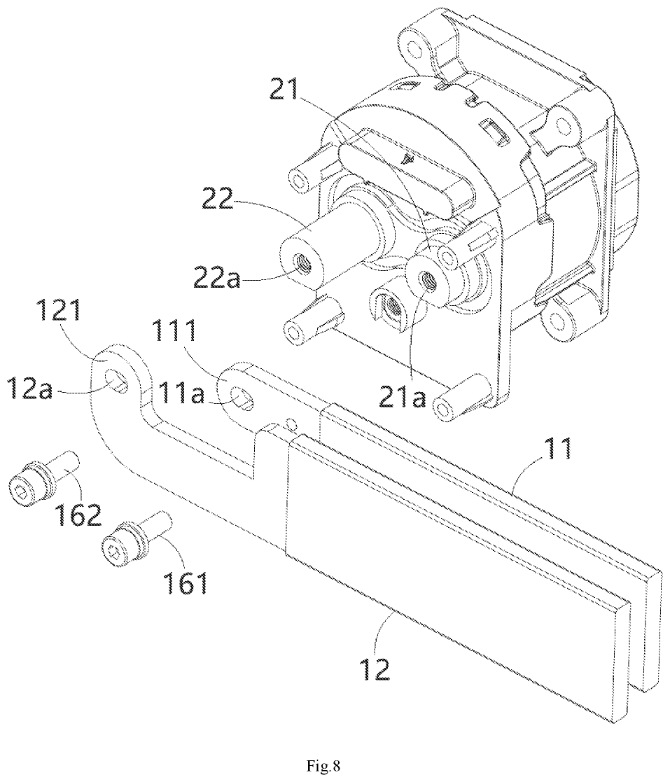

FIG. 6 is a cross-sectional view along an axial direction of a connecting ear 10b of a charging seat assembly according to an exemplary embodiment of the present invention. FIG. 7 is an illustrative view of a metal bar 11, 12 connected to a charging terminal 21, 22 of a charging seat 2 according to an exemplary embodiment of the present invention. FIG. 8 is an illustrative exploded view of a metal bar 11, 12 and a charging seat 2 according to an exemplary embodiment of the present invention.

As shown in FIGS. 1-4, 7 and 8, the housing 10 has a front and rear end opposite in its longitudinal Y direction, as well as a bottom wall 10c and a top wall 10d opposite in its height direction Z. The terminal hole 102 is formed in the bottom wall 10c of the housing 10, and the cover 13 is installed on the rear end of the housing 10. An installation hole 101 is formed in the top wall 10d of the housing 10, and the connecting piece 161, 162 enters the housing 10 through the installation hole 101. A connecting hole 11a, 12a is formed in one end of the metal bar 11, 12, and the connecting piece 161, 162 passes through the connecting hole 11a, 12a and is suitable for threaded connection with a threaded hole 21a, 22a formed in the charging terminal 21, 22 to fasten one end of the metal bar 11, 12 to the charging terminal 21, 22.

As shown in FIGS. 1-8, in the illustrated embodiments, multiple connection ears 10b are formed on the outer side of the housing 10. The connector also includes multiple connection screws 15. The multiple connection screws 15 are used to connect the multiple connection ears 10b to the connecting post 23b of the end cover 23 of the charging seat 2, respectively, to fix the housing 10 to the charging seat 2.

A through hole 106 is formed in the connecting ear 10b, which includes a first hole portion 106a and a second hole portion 106b that are coaxial and communicated with each other. The inner diameter of the second hole portion 106b is greater than that of the first hole portion 106a. The second hole portion 106b is used to position an end of the connecting post 23b of the charging seat 2, and the connecting screw 15 passes through the first hole portion 106a and is connected to a blind hole 2b formed in the connecting post 23b.

The connector further includes an elastic seal 14, which is installed in the rear port 105 of the housing 10. The metal bar 11, 12 passes through the elastic seal 14. The elastic seal 14 is compressed between the inner wall of the housing 10 and the metal bar 11, 12 to achieve sealing between the two. In this way, it is possible to prevent water vapor from entering the housing 10 through the rear port 105 of the housing 10. A positioning step 104 is formed in the rear port 105 of the housing 10, and the positioning step 104 and the cover 13 respectively abut against both ends of the elastic seal 14 to maintain the elastic seal 14 in the rear port 105 of the housing 10.

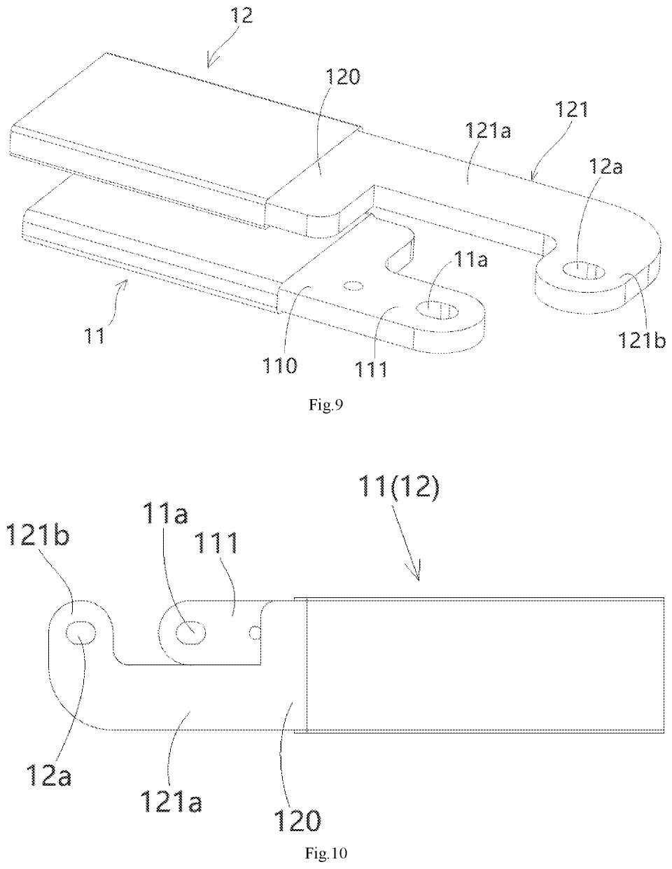

FIG. 9 is a spatial arrangement view of metal bars 11, 12 according to an exemplary embodiment of the present invention. FIG. 10 is a top view of metal bars 11, 12 according to an exemplary embodiment of the present invention.

As shown in FIGS. 1-10, in the illustrated embodiments, the metal bar 11, 12 includes a first metal bar 11 and a second metal bar 12 with the same width. The first metal bar 11 and the second metal bar 12 are used to connect to a first charging terminal 21 and a second charging terminal 22 of the charging seat 2, respectively. The first metal bar 11 and the second metal bar 12 are spaced and overlapped in the height direction Z of the housing 10, so that the two longitudinal sides of the first metal bar 11 are flush with the two longitudinal sides of the second metal bar 12. In the illustrated embodiments, the first metal bar 11 and the second metal bar 12 are inserted into the housing 10 along the longitudinal Y of the housing 10, so that the surfaces of the first metal bar 11 and the second metal bar 12 are parallel to the transverse direction X and the longitudinal direction Y of the housing 10.

The connecting holes 11a, 12a includes a first connecting hole 11a formed in the first metal bar 11 and a second connecting hole 12a formed in the second metal bar 12. The connecting piece 161, 162 includes a first connecting piece 161 and a second connecting piece 162 that pass through the first connecting hole 11a and the second connecting hole 12a, respectively. The first connecting piece 161 and the second connecting piece 162 are used to connect the first metal bar 11 and the second metal bar 12 to the first charging terminal 21 and the second charging terminal 22, respectively.

The dimension of the first connecting hole 11a and the second connecting hole 12a in the length direction of the metal bars 11, 12 are greater than that in the width direction of the metal bars 11, 12. This allows the first connecting member 161 and the second connecting member 162 to move along the length direction of the metal bars 11, 12 in the first connecting hole 11a and the second connecting hole 12a, respectively. In this way, the position error between the metal bar 11, 12 and the charging terminal 21, 22 can be absorbed, making the installation and operation of the metal bar 11, 12 easier and more convenient. The central axis of the first connecting hole 11a and the central axis of the second connecting hole 12a are parallel to each other and located in the same plane perpendicular to the width direction of the metal bars 11, 12.

The first metal bar 11 includes a flat first metal conductor 110 and a first insulator 112 wrapped on the first metal conductor 110. The first metal conductor 110 has a first connection end 111 exposed out of the first insulator 112 for electrical connection to the first charging terminal 21. The first connecting hole 11a is formed in the first connection end 111.

The second metal bar 12 includes a flat second metal conductor 120 and a second insulator 122 wrapped on the second metal conductor 120. The second metal conductor 120 has a second connection end 121 exposed out of the second insulator 122 for electrical connection to the second charging terminal 22. The second connecting hole 12a is formed in the second connection end 121.

The first connection end 111 is spatially avoided from the second connection end 121. In this way, the first connecting hole 11a of the first connection end 111 is not obstructed by the second connection end 121. Therefore, the first connecting piece 161 can be inserted into the first connecting hole 11a of the first connection end 111.

In the illustrated embodiments, the first connection end 111 extends along the length direction of the metal bar 11, 12. The width of the first connection end 111 is not more than half of the width of the metal bar 11, 12, and is offset to one side of the width direction of the metal bar 11, 12. The second connection end 121 is L-shaped, including a first extension portion 121a extending along the length direction of the metal bar 11, 12 and a second extension portion 121b extending along the width direction of the metal bar 11, 12. The first extension portion 121a extends along the length direction of the metal bar 11, 12 beyond the first connection end 111, and the width of the first extension portion 121a is not more than half of the width of the metal bar 11, 12, and is offset to the other side of the width direction of the metal bar 11, 12. Therefore, the first connection end 111 and the second connection end 121 are spatially staggered from each other to ensure that there is no problem of mutual obstruction between the two.

In another exemplary embodiment of the present invention, a charging seat assembly is also disclosed. The charging seat assembly mainly includes the connector 1 and the charging seat 2. The charging seat 2 includes the charging seat housing 20, the charging terminal 21, 22 and the end cover 23. One end of the charging terminal 21, 22 is used for electrical connection with the metal bar 11, 12, and the other end of the charging terminal 21, 22 is used for mating with a mating terminal in a charging gun. The end cover 23 is installed on an end of the charging seat housing 20. In the illustrated embodiment, a snapping slot 23a is formed on the peripheral wall 231 of the end cover 23, and a protrusion 20a is formed on the outside of the charging seat housing 20. The protrusion 20a is snapped into the snapping slot 23a to fix the end cover 23 to the end of the charging seat housing 20.

The housing 10 of connector 1 is fixed to the end cover 23 of the charging seat 2, and one end of the charging terminal 21, 22 passes through a terminal through hole 202 formed in the end cover 23 and is inserted into the housing 10 of connector 1 through the terminal hole 102 of the housing 10 to be electrically connected to the metal bar 11, 12 of connector 1. In the illustrated embodiments, there are multiple connecting posts 23b formed on the top plate 232 of the end cover 23, which are used to respectively connect with multiple connecting ears 10b on the housing 10 of the connector 1 to fix the housing 10 of the connector 1 to the charging seat 2.

The charging terminal 21, 22 includes a first charging terminal 21 and a second charging terminal 22, with the central axes of the first charging terminal 21 and the second charging terminal 22 parallel to each other. One end of the first charging terminal 21 extends axially beyond one end of the second charging terminal 22, so that the end face of one end of the first charging terminal 21 is at a different height position from the end face of one end of the second charging terminal 22. One end of the first metal bar 11 of connector 1 is fastened to the end face of one end of the first charging terminal 21 by the first connecting piece 161. One end of the second metal bar 12 of connector 1 is fastened to the end face of one end of the second charging terminal 22 by the second connecting piece 162.

The charging seat assembly further includes a sealing ring 17, which is arranged between the housing 10 of connector 1 and the end cover 23 of charging seat 2 to achieve sealing between the two. Therefore, it is possible to prevent water vapor from entering the housing 10 of connector 1 and the charging seat housing 20 through a gap between the housing 10 of connector 1 and the end cover 23 of charging seat 2. In the illustrated embodiment, a sealing ring installation groove 234 is formed on the end cover 23 of the charging seat 2, and the sealing ring 17 is installed in the sealing ring installation groove 234.

In an exemplary embodiment of the present invention, the aforementioned metal bar 11, 12 can be an aluminum bar or any other suitable metal bar.

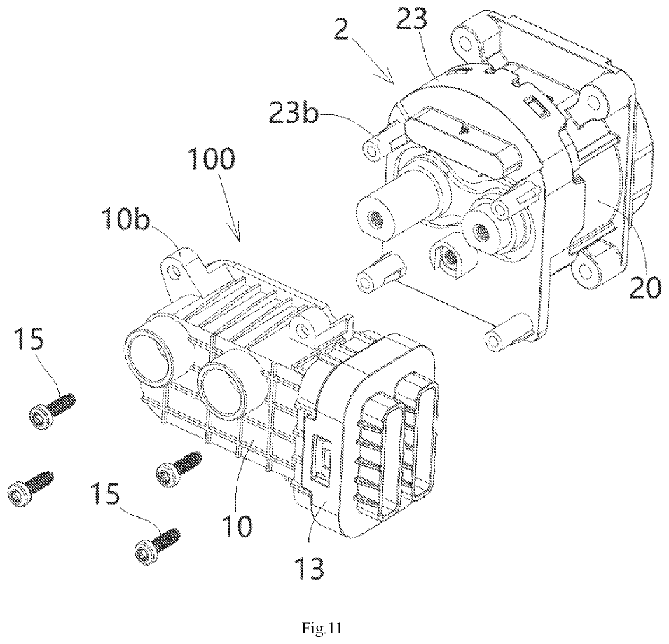

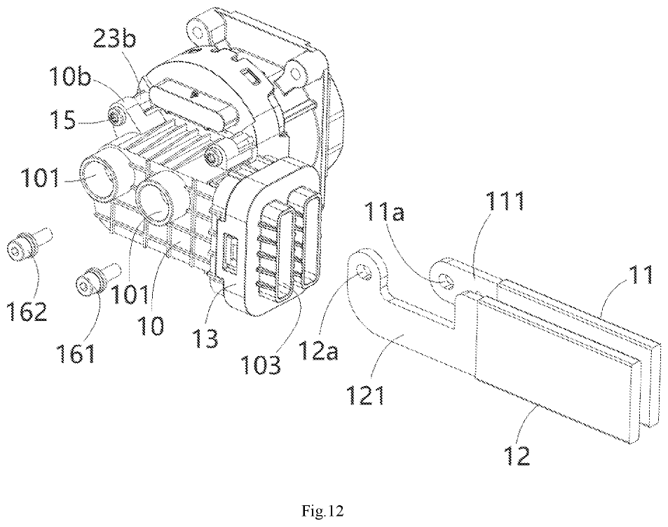

FIG. 11 is an illustrative view of installing a housing 10 of connector 1 onto a charging seat 2 according to an exemplary embodiment of the present invention. FIG. 12 is an illustrative view of inserting a metal bar 11, 12 into the housing 10 of connector 1 according to an exemplary embodiment of the present invention.

The following will refer to FIGS. 11 and 12 to illustrate the process of assembling the charging seat product. Firstly, as shown in FIG. 11, assembling the housing 10, the cover 13, and the elastic seal 14 of the connector 1 together to form a housing assembly 100. Then, as shown in FIG. 12, using connecting screws 15 to connect the housing 10 of connector 1 to the end cover 23 of charging seat 2. Finally, as shown in FIG. 12, inserting the metal bar 11, 12 into the housing 10 of connector 1, and connecting the metal bar 11, 12 to the charging terminal 21, 22 of charging seat 2 by the connecting piece 161, 162.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector for connecting to a charging seat, comprising:
a housing formed with a terminal hole adapted to receive one end of a charging terminal of the charging seat;
a cover arranged on an end of the housing and formed with a conductive element opening;
a conductive element, one end of which is inserted into the housing through the conductive element opening of the cover; and
a connecting piece provided in the housing and adapted to connect the one end of the conductive element to the one end of the charging terminal.

2. The connector according to claim 1, wherein:
the housing includes a front end and a rear end opposite in its longitudinal direction, and a bottom wall and a top wall opposite in its height direction;
the terminal hole is formed in the bottom wall of the housing, and the cover is arranged on the rear end of the housing; and
an installation hole is formed in the top wall of the housing, and the connecting piece enters the housing through the installation hole.

3. The connector according to claim 1, wherein a connecting hole is formed in one end of the conductive element, and the connecting piece passes through the connecting hole and is adapted to form a threaded connection with a threaded hole in the charging terminal to fasten the one end of the conductive element to the charging terminal.

4. The connector according to claim 1, wherein a plurality of connecting ears are formed on an outer side of the housing, and the connector also includes a plurality of connecting screws connecting the connecting ears to connecting posts on an end cover of the charging seat and fixing the housing to the charging seat.

5. The connector according to claim 4, wherein:
a through hole is formed in the connecting ear and includes a first hole portion and a second hole portion that are coaxial and communicated with each other, an inner diameter of the second hole portion is greater than an inner diameter of the first hole portion; and
the second hole portion positions an end of the connecting post of the charging seat, and the connecting screw passes through the first hole portion and is adapted to connect with a blind hole formed in the connecting post.

6. The connector according to claim 1, further comprising an elastic seal installed in a rear port of the housing, the conductive element passes through the elastic seal, and the elastic seal is compressed between an inner wall of the housing and the conductive element.

7. The connector according to claim 6, wherein a positioning step is formed in the rear port of the housing, and the positioning step and the cover respectively abut against each end of the elastic seal to maintain the elastic seal in the rear port of the housing.

8. The connector according to claim 1, wherein:
the conductive element includes a first metal bar and a second metal bar having the same width, and the first metal bar and the second metal bar are used to be respectively connected to a first charging terminal and a second charging terminal of the charging seat; and
the first metal bar and the second metal bar are spaced and overlapped in the height direction of the housing, so that two longitudinal sides of the first metal bar are respectively flush with two longitudinal sides of the second metal bar.

9. The connector according to claim 8, wherein the first metal bar and the second metal bar are inserted into the housing along a longitudinal direction of the housing, surfaces of the first metal bar and the second metal bar are parallel to a transverse direction and the longitudinal direction of the housing.

10. The connector according to claim 8, wherein:
the connecting hole includes a first connecting hole formed in the first metal bar and a second connecting hole formed in the second metal bar;
the connecting piece includes a first connecting piece and a second connecting piece passing through the first connecting hole and the second connecting hole; and
the first connecting piece and the second connecting piece connect the first metal bar and the second metal bar to the first charging terminal and the second charging terminal, respectively.

11. The connector according to claim 10, wherein a size of the first connecting hole and the second connecting hole in a length direction of the conductive element is greater than the size in a width direction of the conductive element, the first connecting piece and the second connecting piece is movable along the length direction of the conductive element in the first connecting hole and the second connecting hole, respectively.

12. The connector according to claim 10, wherein a central axis of the first connecting hole and a central axis of the second connecting hole are parallel to each other and located in the same plane perpendicular to the width direction of the conductive element.

13. The connector according to claim 10, wherein:
the first metal bar comprises a flat first metal conductor and a first insulator wrapped on the first metal conductor, the first metal conductor has a first connection end exposed out of the first insulator for electrical connection to the first charging terminal, and the first connecting hole is formed in the first connection end; and
the second metal bar comprises a flat second metal conductor and a second insulator wrapped on the second metal conductor, the second metal conductor has a second connection end exposed out of the second insulator for electrical connection to the second charging terminal, and the second connecting hole is formed in the second connection end.

14. The connector according to claim 13, wherein the first connection end is spatially separated from the second connection end, so that the first connecting hole in the first connection end is not obstructed by the second connection end.

15. The connector according to claim 14, wherein:
the first connection end extends along a length direction of the conductive element, and a width of the first connection end is not more than half of a width of the conductive element and is offset to one side of a width direction of conductive element;
the second connection end is L-shaped, including a first extension portion extending along the length direction of the conductive element and a second extension portion extending along the width direction of the conductive element; and
the first extension portion extends beyond the first connection end along the length direction of the conductive element, and a width of the first extension portion is not more than half of the width of the conductive element and is offset to the other side of the width direction of the conductive element.

16. The connector according to claim 1, wherein the conductive element is a metal bar.

17. A charging seat assembly, comprising:
a connector, including:
a housing having a terminal hole receiving one end of a charging terminal of the charging seat;
a cover arranged on an end of the housing and formed with conductive element opening;
a conductive element, one end of which is inserted into the housing through the conductive element opening; and
a connecting piece arranged in the housing and adapted to connect the one end of the conductive element to the one end of the charging terminal; and
a charging seat, including:
a charging seat housing;
a charging terminal arranged in the charging seat housing; and
an end cover arranged on an end of the charging seat housing, the housing of the connector is fixed to the end cover of the charging seat, and one end of the charging terminal passes through the end cover and is inserted into the housing of the connector to be electrically connected to the conductive element.

18. The charging seat assembly according to claim 17, wherein multiple connecting posts are formed on the cover and are adapted to connect with multiple connecting ears on the housing of the connector to fix the housing of the connector to the charging seat.

19. The charging seat assembly according to claim 17, wherein:
the charging terminal includes a first charging terminal and a second charging terminal, and central axes of the first charging terminal and the second charging terminal are parallel to each other; and
one end of the first charging terminal extends axially beyond one end of the second charging terminal.

20. The charging seat assembly according to claim 17, further comprising a sealing ring arranged in an installation groove and positioned between the housing of the connector and the cover of the charging seat.
